(19) United States
(12) Patent Application Publication
(10) Pub. No.: US 2026/0048986 A1
(43) Pub. Date: Feb. 19, 2026

(54) ALANE PREPARATION METHOD, PREPARATION SYSTEM AND APPLICATION THEREOF

(71) Applicant: SANSHI INDUSTRIES CO., LTD., NINGBO (CN)

(72) Inventors: LEI WANG, NINGBO (CN); YAHUI SUN, NINGBO (CN); CHAOQI SHEN, NINGBO (CN)

(21) Appl. No.: 19/343,050

(22) Filed: Sep. 29, 2025

Related U.S. Application Data
(63) Continuation of application No. PCT/CN2025/109219, filed on Jul. 18, 2025.

(30) Foreign Application Priority Data
Aug. 19, 2024 (CN) 202411131964.X

(51) Int. Cl. C01B 6/06; C07F 5/06

(52) U.S. Cl. CPC C01B 6/06; C07F 5/062; C01P 2002/70; C01P 2004/04

(57) ABSTRACT

The present disclosure provides an alane preparation method, a preparation system and an application thereof that includes: preparing triethylaluminum: taking triethylaluminum as seeds and aluminum and hydrogen as raw materials, synthesizing triethylaluminum via a direct synthesis method; the triethylaluminum that is newly synthesized contains triethylaluminum of an equal amount as the seeds and triethylaluminum configured to perform alane synthesis; preparing alane: performing thermal decomposition on triethylaluminum that is configured to perform alane synthesis, to obtain alane, wherein the newly synthesized triethylaluminum with an amount equivalent to that of the seeds are used as new seeds for the preparation of new triethylaluminum. The present disclosure only consumes aluminum and hydrogen that are necessary for preparing alane during the preparation process, other raw materials can achieve a balance between consumption and production during the production process.

### CROSS-REFERENCE TO RELATED APPLICATION

The present disclosure is a continuation application of International application No. PCT/CN2025/109219, filed on Jul. 18, 2025, which claims priority to Chinese Patent Application No. 202411131964.X filed on Aug. 19, 2024 with the Chinese Patent Office, the disclosures of which are incorporated herein by reference in their entireties.

### TECHNICAL FIELD

The present disclosure relates to the field of organic synthesis technologies, and especially relates to an alane preparation method, a preparation system and an application thereof.

### BACKGROUND

Alane (AlH₃), also known as aluminum hydride, is a high-energy material. Alane has performances of a high hydrogen density (a mass density of 10.08 wt. %, a volume density of 0.148 kg/L), a relatively low hydrogen release temperature and reaction enthalpy, and a highly controllable hydrogen product purity, so that it is an ideal hydrogen storage material that can be used in conjunction with fuel cells.

However, alane has at least seven known polymorphic forms, and its high difficulty in synthesis, controllable tunability in chemical modification, and high production costs limit its application range in energy products. As determined by reaction thermodynamic properties, an equilibrium hydrogen pressure of aluminum at room temperature is around 7 kbar (0.7 GPa). Therefore, only at extremely high hydrogen pressures (>0.7 GPa), the aluminum metal can directly react with hydrogen to produce alane. However, this reaction condition cannot be achieved in industrial production, and it is difficult to achieve controllability in the properties of alane crystals produced via a direct reaction between high-pressure hydrogen and a metal.

At present, the synthesis of alane mostly adopts liquid-phase organic chemical synthesis methods and their variants. The principle is to use excess lithium aluminum hydride and aluminum chloride to react in anhydrous ether solvents to produce alane-ether complexes, followed to perform ether removal and crystal transformation to obtain non-solvated alane. For example, Chinese patent application CN 106946224 A discloses a method for preparing alpha aluminum hydride via applying a mixed catalyst of lithium aluminum hydride and lithium borohydride. Usually, to ensure ideal crystal transformation, a large volume of benzene-based solvents is used in conjunction with this process. This liquid-phase organic chemical synthesis method has a high yield and is relatively mature, but requires a large amount of lithium aluminum hydride and ether as reaction raw materials. A consumption of lithium is the main reason for the high production cost and safety hazards in the production process. In addition, the hydrogen that needs to be widely consumed is not the raw material that is required for this synthesis method. Therefore, if alane is to be used as a hydrogen supply material for fuel cells, this production method would be economically unfeasible.

### SUMMARY

Given technical features of conventional alane synthesis technologies, how to reduce a preparation cost of alane and improve production safety is an urgent technical problem that an ordinary skill in the art needs to solve.

The technical solution adopted for solving above technical problems of the present disclosure is implemented as follows.

A first aspect of the present disclosure provides an alane preparation method including:
preparing triethylaluminum: taking triethylaluminum as seeds and aluminum and hydrogen as raw materials, synthesizing triethylaluminum via a direct synthesis method; the triethylaluminum that is newly synthesized contains triethylaluminum of an equal amount as the seeds and triethylaluminum configured to perform alane synthesis;
preparing alane: performing thermal decomposition on triethylaluminum that is configured to perform alane synthesis, to obtain alane, wherein the newly synthesized triethylaluminum with an amount equivalent to that of the seeds are used as new seeds for the preparation of new triethylaluminum.

In some embodiments, a preparation process of triethylaluminum in the alane preparation method includes:
a preparation of diethylaluminum hydride: in a first reaction vessel, adding hydrogen and triethylaluminum that is taken as seeds to the aluminum suspension to generate diethylaluminum hydride; and

a preparation of newly synthesized triethylaluminum: adding the diethylaluminum hydride that is generated into a second reaction vessel, introducing a raw material ethylene into the second reaction vessel, and heating to generate newly synthesized triethylaluminum.

In some embodiments, a preparation process of alane in the alane preparation method includes: in a third reaction vessel, performing thermal decomposition on triethylaluminum that is configured to perform alane synthesis under an action of surfactants, to obtain alane and newly generated ethylene; and wherein
an amount of the newly generated ethylene is equal to that of the raw material ethylene, and the newly generated ethylene is recovered and purified for the preparation of triethylaluminum.

In some embodiments of the alane preparation method, reaction conditions in the first reaction vessel are: gas inside the first reaction vessel is hydrogen, after being sealed, an internal hydrogen pressure of the first reaction vessel is 6-10 MPa, a reaction temperature is 100-150° C., and a reaction time is 2-6 hours.

In some embodiments of the alane preparation method, reaction conditions in the second reaction vessel are: gas inside the second reaction vessel is ethylene, after being sealed, an internal ethylene pressure of the second reaction vessel is 0.4-1 MPa, a reaction temperature is 60-100° C., and a reaction time is 5-8 hours.

In some embodiments of the alane preparation method, reaction conditions in the third reaction vessel are: gas inside the third reaction vessel is hydrogen, after being sealed, an internal hydrogen pressure of the third reaction vessel is 3-6 MPa, a reaction temperature is 150-180C°, and a reaction time is 6-10 hours.

A second aspect of the present disclosure provides an alane preparation system that applies to the above preparation method, and the system includes:
first and second reaction vessels configured to preparing triethylaluminum; taking triethylaluminum as seeds, synthesizing triethylaluminum via a direct synthesis method, wherein the triethylaluminum that is newly synthesized contains triethylaluminum of an equal amount as the seeds and triethylaluminum configured to perform alane synthesis;
a third reaction vessel is used for preparing alane which is configured to perform thermal decomposition on triethylaluminum that is configured to perform alane synthesis, to obtain alane; and
a connecting tubing connected to the first reaction vessel and the second reaction vessel, and configured to transport the newly synthesized triethylaluminum with an equal molar quantity to that of the seeds from the second reaction vessel to the first reaction vessel, to take as new seeds for synthesizing triethylaluminum.

In some embodiments of the alane preparation system, the system further includes:
a gas separation device connected to a gas output terminal of the third reaction vessel, and in communication with the gas output terminal of the third reaction vessel, where the gas separation device is configured to separate hydrogen and ethylene that are output from the third reaction vessel; and
a solvent purification circulation system connected to a solvent output terminal of the third reaction vessel, and configured to purify and recycle the solvent for reuse.

In some embodiments of the alane preparation system, the system further includes:
a hydrogen purification circulation system configured to purify hydrogen and including a plurality of first input terminals and a plurality of first output terminals, the plurality of first input terminals respectively connected to a hydrogen output terminal of the gas separation device and a hydrogen output terminal of the first reaction vessel, the plurality of first output terminals respectively connected to a hydrogen input terminal of the first reaction vessel and a hydrogen input terminal of the third reaction vessel;
a plurality of first booster pumps arranged on the corresponding first output terminals, and configured to increase a pressure of hydrogen that is delivered to the first reaction vessel and the third reaction vessel to a preset value;
an ethylene purification circulation system configured to purify ethylene and including a plurality of second input terminals and a second output terminal, the plurality of second input terminals connected to an ethylene output terminal of the second reaction vessel and an ethylene output terminal of the gas separation device, respectively, the second output terminal connected to an ethylene input terminal of the second reaction vessel;
a second booster pump correspondingly set at the second output terminal, and configured to increase a pressure of ethylene that is delivered to the second reaction vessel to a preset value; and wherein
after the reactions in the first reaction vessel, the second reaction vessel and the third reaction vessel are completed, remaining hydrogen and ethylene are correspondingly transported to the hydrogen purification circulation system and the ethylene purification circulation system for performing purification and recycling thereof.

A third aspect of the present disclosure provides an application of the alane prepared via the above preparation method as a hydrogen supply material for fuel cells.

The present disclosure, compared with the related art, provides the advantages as below.

The alane preparation method, the preparation system and an application thereof described in the present disclosure involve hydrogenation through the synthesis process of triethylaluminum for allowing hydrogen to enter the material system, and thermal decomposition process of triethylaluminum is performed under an action of surfactants to synthesize alane. This method completes storage of hydrogen in the carrier metal aluminum through a chemical process, which is suitable for synthesizing alane for a purpose of hydrogen carrying fuel, and can be used for regeneration of remaining aluminum powder after hydrogen release from alane. Meanwhile, the method eliminates the need for large quantities of lithium aluminum hydride and ether solvents, thereby significantly reducing costs and achieving higher safety standards.

The alane preparation method, the preparation system and an application thereof described in the present disclosure only consume raw materials of aluminum and hydrogen in the entire preparation process, other substances involved in the reaction can be generated in equal amounts during the preparation process and recycled for the preparation of alane, which indirectly realizes to the production of alane via using aluminum and hydrogen as raw materials, with high controllability of the production process, high utilization efficiency of raw materials and reduced emissions. In addition, it is suitable for industrial production with high safety factors and low production costs to achieve large-scale mass production.

### BRIEF DESCRIPTION OF THE DRAWINGS

FIG. 1 is a first flowchart of an alane preparation method of the present disclosure.

FIG. 2 is a second flowchart of the alane preparation method of the present disclosure.

FIG. 3 is a schematic view of an alane preparation system of the present disclosure.

FIG. 4 is XRD patterns of alane samples prepared via the alane preparation methods described in a first embodiment and a second embodiment of the present disclosure.

FIG. 5 is a TEM image of alane prepared via the alane preparation method of the first embodiment of the present disclosure.

FIG. 6 is a TEM image of alane prepared via the alane preparation method of the second embodiment of the present disclosure.

### DETAILED DESCRIPTION

Now, in conjunction with the accompanying drawings, preferred exemplary embodiments of the present disclosure will be described in detail. This detailed description should not be construed as a limitation of the present disclosure, but rather as a more detailed description of certain aspects, features and embodiments of the present disclosure.

It should be understood that terms used in the present disclosure are only for describing specific embodiments and are not intended to limit the present disclosure. In addition, a numerical range of the present disclosure should be understood as specifically disclosing upper and lower limits of the range, as well as each intermediate value between the upper and lower limits. Any intermediate value within any stated values or ranges, as well as any smaller range between any other stated values or intermediate values within the ranges, are also included in the present disclosure. These smaller upper and lower limits can be independently included or excluded within the range.

Unless otherwise specified, all technical and scientific terms used in the present disclosure have the same meanings as those commonly understood by one ordinary skilled in the art of the present disclosure. Although the present disclosure only describes preferred methods and materials, any methods and materials similar or equivalent to the methods and materials described herein can also be used in the implementation or verification of the present disclosure. All references mentioned in the specification are incorporated by reference to disclose and describe methods and/or materials related to the mentioned references. In case of conflict with any incorporated references, it is subjected to contents of the present disclosure.

Terms such as “including”, “comprising”, “possessing”, “containing” etc. used in the present disclosure are all open-ended terms, which means that it can include but is not limited to. Regarding the term of “and/or” in the present disclosure, it includes any or all combinations of the mentioned things. Unless otherwise specified, a symbol of % refers to a mass volume percentage.

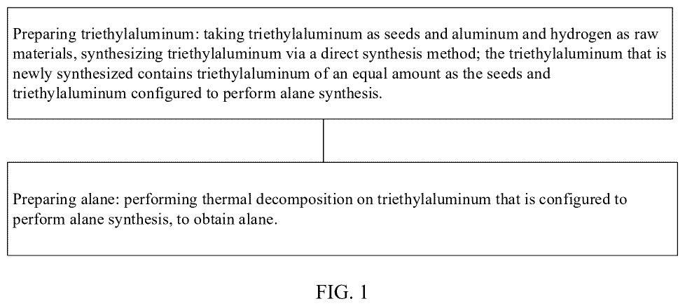

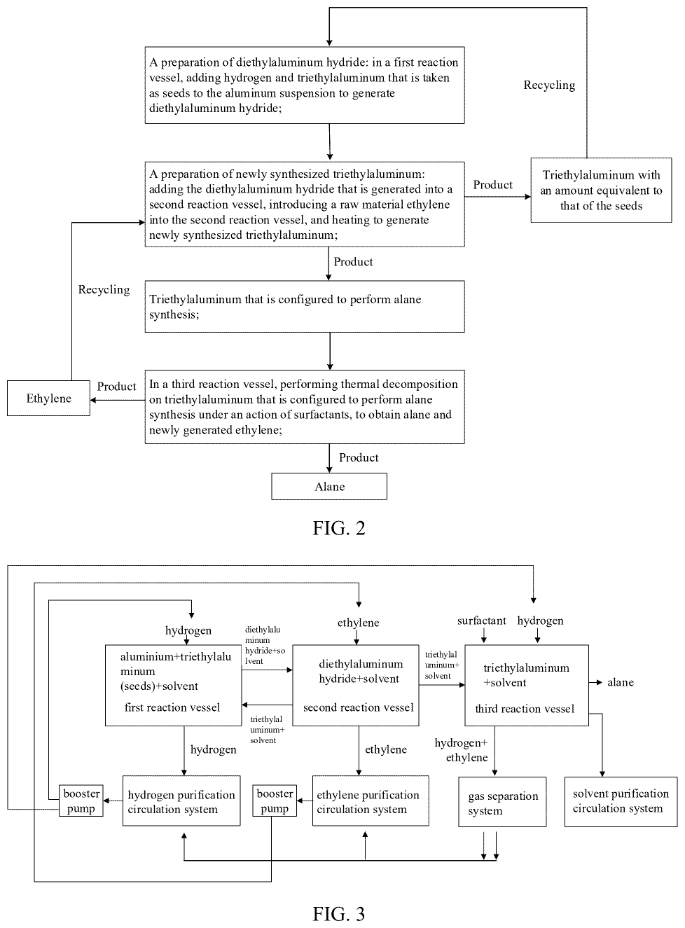

Referring to FIG. 1 and FIG. 2, an alane preparation method according to an embodiment of the present disclosure includes:
a preparation of triethylaluminum including:
a preparation of diethylaluminum hydride: in a first reaction vessel, adding hydrogen and triethylaluminum that is taken as seeds to the aluminum suspension to generate diethylaluminum hydride;
reaction in the first reaction vessel:

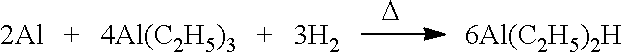

a preparation of newly synthesized triethylaluminum: adding the diethylaluminum hydride that is generated in the first reaction vessel into a second reaction vessel, introducing a raw material ethylene into the second reaction vessel, and heating to generate newly synthesized triethylaluminum;
reaction in the second reaction vessel:

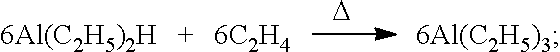

preparing alane: in a third reaction vessel, performing thermal decomposition on triethylaluminum that is configured to perform alane synthesis under an action of surfactants, to obtain alane and newly generated ethylene;
reaction in the third reaction vessel:

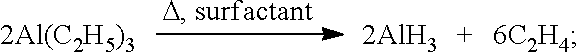

an overall reaction of reactions in the three reaction vessels is:

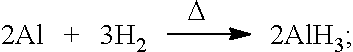

wherein an amount of Al(C₂H₅)₃ that is generated in the second reaction vessel is equal to an amount of Al(C₂H₅)₃ that is consumed in the first and third reaction vessels. An amount of C₂H₄ that is generated in the third reaction vessel is equal to an amount of C₂H₄ that is consumed in the second reaction vessel. That is, in the entire process of preparing alane, only the raw materials aluminum and hydrogen are consumed, and other raw materials can be generated in equal amounts during the preparation process and recycled reuse

In the above scheme, the aluminum suspension is prepared by thoroughly mixing aluminum powder and solvent at a room temperature. The solvent is a solvent that does not dissolve alane, furthermore, the solvent is an alkane solvent that does not dissolve alane and can dissolve the selected surfactants, such as cyclohexane and dodecane.

In the above scheme, in the third reaction vessel, a concentration of the surfactant is 0.3-6 mM; In some embodiments, the concentration of the surfactant can be selected from any of 0.3 mM, 0.5 mM, 1 mM, 1.5 mM, 2 mM,2.5 mM, 3 mM, 3.5 mM, 4 mM, 4.5 mM, 5 mM, 5.5 mM and 6 mM.

The surfactant is a long-chain surfactant that can effectively stabilize the alane that is generated by performing decomposition on triethylaluminum, such as sodium dodecyl sulfate (SDS), hexadecyl trimethyl ammonium bromide (CTAB), or sodium triacetoxyborohydride (STAB).

In the above scheme, reaction conditions in the first reaction vessel are: gas inside the first reaction vessel is hydrogen, after being sealed, an internal hydrogen pressure is 6-10 MPa, a reaction temperature is 100-150° C., and a reaction time is 2-6 hours.

In some embodiments, the reaction conditions in the first reaction vessel are: after being sealed, the internal hydrogen pressure of the first reaction vessel is 6 MPa, 7 MPa, 8 MPa, 9 MPa or 10 MPa;

the reaction temperature in the first reaction vessel is 100° C., 110° C., 120° C., 125° C., 130° C., 140° C. or 150° C.;

the reaction time in the first reaction vessel is 2 hours, 3 hours, 4 hours, 5 hours or 6 hours.

In some embodiments, the reaction conditions in the second reaction vessel are:
the internal ethylene pressure of the sealed second reaction vessel is 0.4 MPa, 0.5 MPa, 0.6 MPa, 0.7 MPa, 0.8 MPa, 0.9 MPa or 1 MPa;
the reaction temperature in the second reaction vessel is 60° C., 70° C., 75° C., 80° C., 90°° C. or 100° C.;
the reaction time in the second reaction vessel is 5 hours, 6 hours, 6.5hours, 7 hours or 8 hours.

In the above scheme, reaction conditions in the third reaction vessel are:
after being sealed, the internal hydrogen pressure of the third reaction vessel is 3 MPa, 4 MPa, 4.5 MPa, 5 MPa or 6 MPa;
the reaction temperature in the third reaction vessel is 150° C., 160° C., 165° C., 170° C., 175° C. or 180° C.;
the reaction time in the third reaction vessel is 6 hours, 7 hours, 7.5 hours, 8 hours, 9 hours or 10 hours.

Referring to FIG. 3, a second aspect of the present disclosure provides an alane preparation system that applies to the above preparation method, and the system includes:
a first reaction vessel, raw materials: triethylaluminum (seeds), hydrogen, and a suspension of aluminum in the solvent; internal gas: hydrogen; a final product: diethyl aluminum hydride and unreacted solvent;
a first connecting tubing connected to the first reaction vessel and the second reaction vessel and configured to transport the final product from the first reaction vessel to the second reaction vessel;
a second reaction vessel, raw materials: diethyl aluminum hydride that is generated in the first reaction vessel, is reacted to ethylene to produce newly synthesized triethylaluminum; internal gas: ethylene; the final product: a liquid product which includes triethylaluminum and solvent; and wherein, ⅔ of the liquid product contains triethylaluminum of an equal amount to that of the triethylaluminum as the seeds in the first reaction vessel. The ⅔ liquid product is transported to the first reaction vessel for cyclic production, and the remaining ⅓ liquid product is transported to the third reaction vessel for the production of alane;
a second connecting tubing connected to the second reaction vessel and the third reaction vessel, and configured to transport the remaining ⅓ liquid product to the third reaction vessel for the production of alane;
a third connecting tubing connected to the second reaction vessel and the first reaction vessel, and configured to transport the ⅔ liquid product to the first reaction vessel for the cyclic production;
a third reaction vessel, raw materials: triethylaluminum; internal gas: hydrogen; the final product: alane, hydrogen and ethylene;
a gas separation device connected to a gas output terminal of the third reaction vessel, and in communication with the gas output terminal of the third reaction vessel, where the gas separation device is configured to separate hydrogen and ethylene that are output from the third reaction vessel; and
a solvent purification circulation system connected to a solvent output terminal of the third reaction vessel, and configured to purify and recycle the solvent for reuse.

In some embodiments, the gas separation device can be a gas membrane separation device, a pressure swing adsorption device and a cryogenic distillation device, etc., wherein the gas membrane separation device can use palladium based metal membranes, carbon molecular sieve membranes (CMSM), electrochemical hydrogen pump membranes (EHPM), and ionic liquid (IL) membranes to separate hydrogen from a gas mixture of hydrogen and ethylene.

A hydrogen purification circulation system is configured to purify hydrogen and includes a plurality of first input terminals and a plurality of first output terminals, the plurality of first input terminals respectively connected to hydrogen output terminals of the gas separation device and hydrogen output terminals of the first reaction vessel, the plurality of first output terminals respectively connected to a hydrogen input terminal of the first reaction vessel and a hydrogen input terminal of the third reaction vessel;

A plurality of first booster pumps is arranged on the corresponding first output terminals, and configured to increase a pressure of hydrogen that is delivered to the first reaction vessel and the third reaction vessel to a preset value.

An ethylene purification circulation system is configured to purify ethylene and includes a plurality of second input terminals and a second output terminal, the plurality of second input terminals connected to an ethylene output terminal of the second reaction vessel and an ethylene output terminal of the gas separation device, respectively, the second output terminal connected to an ethylene input terminal of the second reaction vessel.

A second booster pump is correspondingly set at the second output terminal, and configured to increase a pressure of ethylene that is delivered to the second reaction vessel to a preset value.

After the reactions in the first reaction vessel, the second reaction vessel and the third reaction vessel are completed, remaining hydrogen and ethylene are correspondingly transported to the hydrogen purification circulation system and the ethylene purification circulation system for performing purification and recycling thereof.

A third aspect of the present disclosure provides an application of the alane prepared via the above preparation method as a hydrogen supply material for fuel cells. The alane preparation method of the present disclosure consumes aluminum and hydrogen as raw materials. As one of the raw materials, hydrogen directly enters the production process and is ultimately converted into alane, thereby completing the storage of hydrogen in the carrier metal aluminum. It is suitable for synthesizing alane for the purpose of hydrogen carrying fuels.

The following are preferred embodiments of the present disclosure.

### A First Embodiment

The first embodiment prepares alane according to the following steps below:
step 1, adding 54 g of aluminum powder and 18L of cyclohexane into the first reaction vessel, mixing thoroughly at room temperature to form a suspension, adding 914 g of triethylaluminum to the aluminum powder suspension, stirring thoroughly following by sealing the reaction vessel;
step 2, evacuating the first reaction vessel, then filling the first reaction vessel with hydrogen to a pressure of 10 MPa, raising a temperature of the first reaction vessel to 130° C. and keeping the temperature at 130° C. for 5 hours;
step 3, after the reaction in the first reaction vessel is complete, lowering the temperature to room temperature, recovering the remaining hydrogen in the first reaction vessel, and transferring a liquid product to the second reaction vessel;
step 4, evacuating the second reaction vessel, then filling the second reaction vessel with ethylene to a pressure of 0.5 MPa, raising the temperature to 80° C. and keeping the temperature at 80° C. for 6 hours, to obtain the liquid product;
step 5, after the reaction in the second reaction vessel is complete, the temperature is lowered to room temperature, and the remaining ethylene in the second reaction vessel is recovered. ⅔ of the liquid product is used as new triethylaluminum seeds, and the remaining ⅓ of the liquid product is introduced into the third reaction vessel for decomposition;
step 6, adding 4 g of CTAB to the third reaction vessel containing triethylaluminum to be decomposed, and filling the third reaction vessel with hydrogen to a pressure of 6 MPa, and then raising the temperature of the third reaction vessel to 160° C. and keep the temperature at 160° C. for 8 hours;
step 7, after the reaction in the third reaction vessel is complete, lowering the temperature to room temperature and recovering the gas in the reaction vessel; filtering the post-reaction solid-liquid mixture, collecting the solid product and washing the solid product repeatedly with anhydrous ethanol three times, and then drying the solid product under a vacuum at a temperature of 50° C. to obtain 58 g of product alane, thereby achieving a yield of 98% and a purity of 96%. (The synthesized alane contains a small amount of surfactants).

### A Second Embodiment

step 1, adding 54 mg of aluminum powder and 18 mL of cyclohexane into the first reaction vessel, mixing thoroughly at room temperature to form a suspension, adding 914 mg of triethylaluminum to the aluminum powder suspension, stirring thoroughly followed by sealing the reaction vessel;
step 2, evacuating the first reaction vessel, then filling the first reaction vessel with hydrogen to a pressure of 8 MPa, raising a temperature of the first reaction vessel to 130° C. and keeping the temperature at 130° C. for 4 hours;
step 3, after the reaction in the first reaction vessel is complete, lowering the temperature to room temperature, recovering the remaining hydrogen in the first reaction vessel, and transferring a final product to the second reaction vessel;
step 4, evacuating the second reaction vessel, then filling the second reaction vessel with ethylene to a pressure of 0.5 MPa, raising the temperature to 80° C. and keeping the temperature at 80° C. for 6 hours, to obtain a liquid product;
step 5, after the reaction in the second reaction vessel is complete, the temperature is lowered to room temperature, and the remaining ethylene in the second reaction vessel is recovered. ⅔ of the liquid product is used as triethylaluminum seeds for a next batch, and the remaining ⅓ of the liquid product is introduced into the third reaction vessel for decomposition;
step 6, adding 10 mg of STAB to the third reaction vessel containing triethylaluminum to be decomposed, and filling the third reaction vessel with hydrogen to a pressure of 6 MPa, and then raising the temperature of the third reaction vessel to 150° C. and keep the temperature at 150° C. for 6 hours;
step 7, after the reaction in the third reaction vessel is complete, lowering the temperature to room temperature and recovering the gas in the reaction vessel; filtering the post-reaction solid-liquid mixture, collecting the solid product and washing the solid product repeatedly with anhydrous ethanol three times, and then drying the solid product under a vacuum at a temperature of 50° C. to obtain 5 9mg of product alane, thereby achieving a yield of 98% and a purity of 96%. (The synthesized alane contains a small amount of surfactants).

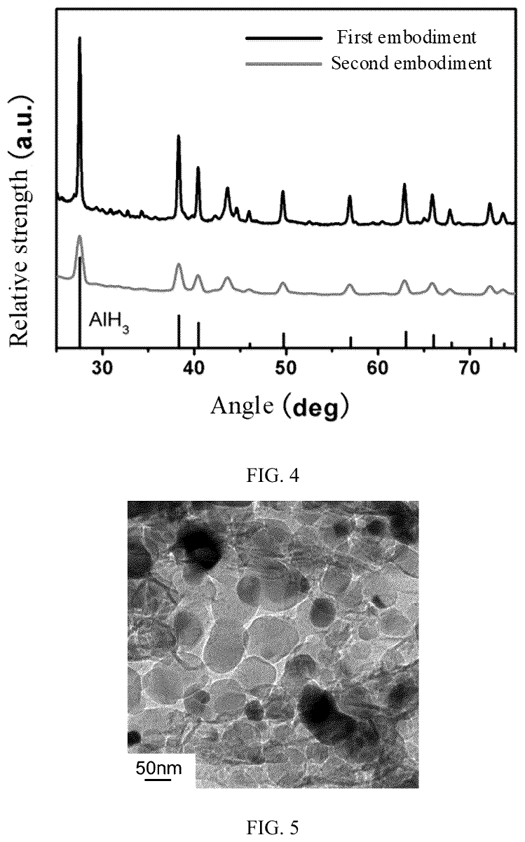

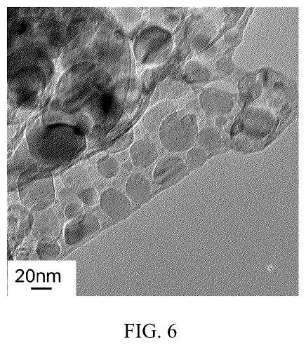

Referring to FIG. 3 to FIG. 5, X-ray diffraction phase analysis is performed on alane samples prepared in the first embodiment and the second embodiment, and clear characteristic peaks of alane are observed in the spectra, which proves a successful synthesis of alane. As observed under a transmission electron microscope, under a stabilizing effect of surfactants, alane particles that are prepared are nano-sized.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

### INDUSTRIAL APPLICABILITY

The present disclosure directly uses hydrogen as the raw material and completes the storage of hydrogen in the carrier metal aluminum through the chemical process, which is suitable for synthesizing alane for the purpose of hydrogen carrying fuels and can be used for a regeneration of the remaining aluminum powder after hydrogen release from alane. Meanwhile, compared with conventional technologies, the cost can be significantly reduced and the safety level is relatively high. In addition, according to the production process that is designed by the method, most of chemical raw materials can be recycled within the process, thereby improving utilization efficiency of the raw materials and atomic economy, and reducing emissions. The alane preparation method of the present disclosure enables large-scale industrial production of alane. Compared with the conventional technologies, the present disclosure can enhance safety performance, lower production costs, have a highly favorable input-output ratio and superior economic efficiency.

What is claimed is:

1. An alane preparation method comprising:
preparing triethylaluminum comprising a preparation of diethylaluminum hydride and a preparation of newly synthesized triethylaluminum: in a first reaction vessel, adding hydrogen and triethylaluminum that is taken as seeds to the aluminum suspension to generate diethylaluminum hydride; adding the diethylaluminum hydride that is generated into a second reaction vessel, introducing a raw material ethylene into the second reaction vessel, and heating to generate newly synthesized triethylaluminum; and wherein the newly synthesized triethylaluminum contains triethylaluminum with an amount equivalent to that of the triethylaluminum seeds and triethylaluminum configured to perform alane synthesis;
preparing alane: in a third reaction vessel, performing thermal decomposition on triethylaluminum that is configured to perform alane synthesis under an action of surfactants, to obtain alane and newly generated ethylene; and wherein the newly synthesized triethylaluminum with an amount equivalent to that of the triethylaluminum seeds are taken as new seeds for the preparation of new triethylaluminum; an amount of the newly generated ethylene is equal to that of the raw material ethylene, and the newly generated ethylene is recovered and purified for the preparation of triethylaluminum; and wherein
the surfactant is a long-chain surfactant, a concentration of the surfactant is 0.3-6 mM, gas inside the third reaction vessel is hydrogen, with a pressure of 3-6 MPa, a reaction temperature of 150-180C°, and a reaction time of 6-10 hours.

2. The preparation method as claimed in claim 1, wherein reaction conditions in the first reaction vessel are: gas inside the first reaction vessel is hydrogen, after being sealed, an internal hydrogen pressure of the first reaction vessel is 6-10 MPa, a reaction temperature is 100-150° C., and a reaction time is 2-6 hours.

3. The preparation method as claimed in claim 1, wherein reaction conditions in the second reaction vessel are: gas inside the second reaction vessel is ethylene, an internal ethylene pressure of the sealed second reaction vessel is 0.4-1 MPa, a reaction temperature is 60-100° C., and a reaction time is 5-8 hours.

4. An alane preparation system configured to apply the preparation method as claimed in claim 1, the preparation system comprising:
the first and second reaction vessels configured to prepare triethylaluminum; taking triethylaluminum as seeds, synthesizing triethylaluminum via a direct synthesis method, wherein the triethylaluminum that is newly synthesized contains triethylaluminum of an equal amount as the seeds and triethylaluminum configured to perform alane synthesis;
the third reaction vessel is used for preparing alane which is configured to perform thermal decomposition on triethylaluminum that is configured to perform alane synthesis, to obtain alane; and
a connecting tubing connected to the first reaction vessel and the second reaction vessel, and configured to transport the newly synthesized triethylaluminum from the second reaction vessel to the first reaction vessel, in an equal molar quantity to that of the seeds, to be taken as new seeds for synthesizing triethylaluminum.

5. The preparation system as claimed in claim 4, wherein the system further comprises:
a gas separation device connected to a gas output terminal of the third reaction vessel, and in communication with the gas output terminal of the third reaction vessel, where the gas separation device is configured to separate hydrogen and ethylene that are output from the third reaction vessel; and
a solvent purification circulation system connected to a solvent output terminal of the third reaction vessel, and configured to purify and recycle the solvent for reuse.

6. The preparation system as claimed in claim 5, wherein the system further comprises:
a hydrogen purification circulation system configured to purify hydrogen and comprising a plurality of first input terminals and a plurality of first output terminals, the plurality of first input terminals respectively connected to hydrogen output terminals of the gas separation device and hydrogen output terminals of the first reaction vessel, the plurality of first output terminals respectively connected to a hydrogen input terminal of the first reaction vessel and a hydrogen input terminal of the third reaction vessel;
a plurality of first booster pumps arranged on the corresponding first output terminals, and configured to increase a pressure of hydrogen that is delivered to the first reaction vessel and the third reaction vessel to a preset value;
an ethylene purification circulation system configured to purify ethylene and comprising a plurality of second input terminals and a second output terminal, the plurality of second input terminals connected to an ethylene output terminal of the second reaction vessel and an ethylene output terminal of the gas separation device, respectively, the second output terminal connected to an ethylene input terminal of the second reaction vessel;
a second booster pump correspondingly set at the second output terminal, and configured to increase a pressure of ethylene that is delivered to the second reaction vessel to a preset value; and wherein
after the reactions in the first reaction vessel, the second reaction vessel and the third reaction vessel are completed, remaining hydrogen and ethylene are correspondingly transported to the hydrogen purification circulation system and the ethylene purification circulation system for performing purification and recycling thereof.
